(19) United States
(12) Patent Application Publication
(10) Pub. No.: US 2010/0222937 A1
(43) Pub. Date: Sep. 2, 2010

(54) HEATER CONTROL SYSTEM

(75) Inventors: MARK D. NEMESH, Troy, MI (US); CHANDRA S. NAMUDURI, Troy, MI (US); WISSAM IBRI, Sterling Heights, MI (US); MATTHEW J. MARTINCHICK, Farmington, MI (US); ANDREW J. FARAH, Troy, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/394,516

(22) Filed: Feb. 27, 2009

(51) Int. Cl. G05D 23/00

(52) U.S. Cl. 700/300

(57) ABSTRACT

A heater control system is provided that comprises a plurality of n banks of heating elements H₁, H₂, H₃, H₄, . . . , Hₙ each containing at least one heating element. Each one of a plurality of switches Q₁, Q₂, Q₃, Q₄, . . . , Qₙ is coupled to a respective one of the plurality of banks for selectively activating the plurality of banks. Each one of a plurality of control inputs is coupled to a different one of the plurality of switches to selectively activate the plurality of switches.

### TECHNICAL FIELD

This invention relates generally to a heater control system, and more particularly to a heater control system utilizing power/current amplitude modulation.

### BACKGROUND OF THE INVENTION

Increasing demands for improved fuel economy and reduced emissions have lead to improvements and developments in hybrid vehicles, electric vehicles, and vehicles powered by fuel cells and diesel fuel. Such vehicles, however, characteristically generate little or no supplemental engine heat for cabin heating, windshield defrosting, and the like. As a result, supplemental heaters, typically positive temperature-coefficient (PTC) heaters, are employed to provide the requisite supplemental heat. The heating stages of PTC heaters (both the high voltage and low voltage stages) have traditionally been driven/controlled using voltage pulse-width-modulation (PWM) switching control. However, this technique results in incomplete overlapping of the individual heater circuits as the heater output is continuously varied. The result is the generation of significant ripple current on the supply line. This ripple current may be compensated for through the use of additional capacitance, and/or inductance, and/or higher frequency switching of the individual heating elements. Each of these solutions, however, is costly and complex, especially for heating systems having additional control parameters. Additionally, with such solutions, the usable control range of a PWM heater can be affected as system voltage varies.

It would therefore be desirable to provide an improved heater control system having enhanced power control as the system voltage varies. It is further desirable to provide an improved heater control system having reduced ripple current. It is still further desirable that the improved heater control system be simpler and less costly than known heater control systems.

### SUMMARY OF THE INVENTION

A heater control system is provided that comprises a plurality of n banks of heating elements (H₁, H₂, H₃, H₄, . . . , Hₙ) each containing at least one heating element. Each one of a plurality of switches Q₁, Q₂, Q₃, Q₄, . . . , Qₙ is coupled to a respective one of the plurality of banks for selectively activating the plurality of banks of heating elements. Each one of a plurality of control inputs representing a desired heating level is coupled to a different one of the plurality of switches.

Further, there is provided a heater control system that comprises a plurality of n banks of heating elements (H₁, H₂, H₃, H₄, . . . , Hₙ) each bank comprising Xⁿ heating elements. Each of a plurality of switches Q₁, Q₂, Q₃, Q₄, . . . , Qₙ is coupled to a different one of the plurality of n banks, and each of a plurality of driver circuits is coupled to one of the plurality of switches. A controller has an input for receiving a signal indicative of a desired heating level and has n outputs each one coupled to a respective one of the plurality of driver circuits. The controller is configured to generate a binary representation of the signal on the n outputs to selectively activate the plurality of n banks of heating elements

### DESCRIPTION OF THE DRAWINGS

The present invention will hereinafter be described in conjunction with the following drawing figures, wherein like numerals denote like elements, and:

FIG. 1 is a schematic diagram of a heater control system in accordance with a first exemplary embodiment; and

FIG. 2 is a table describing the operation of an exemplary heater control system of the type shown in FIG. 1.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

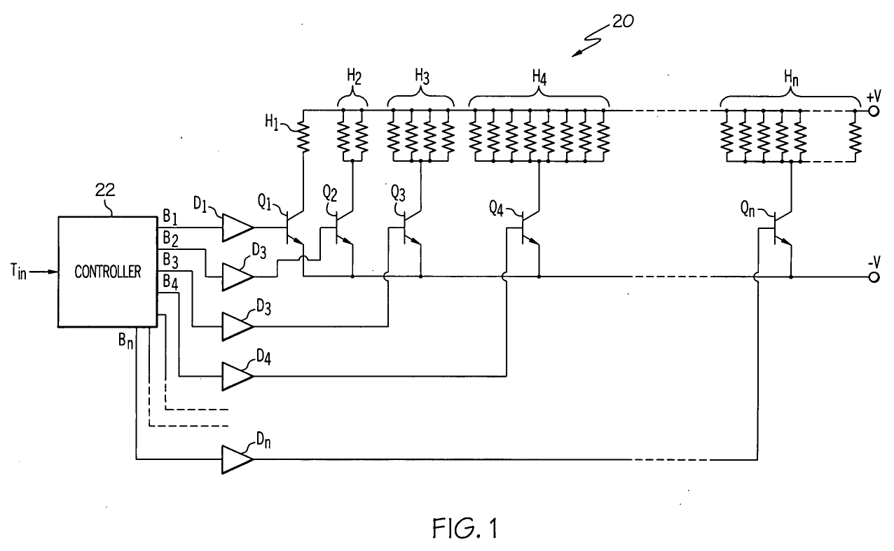

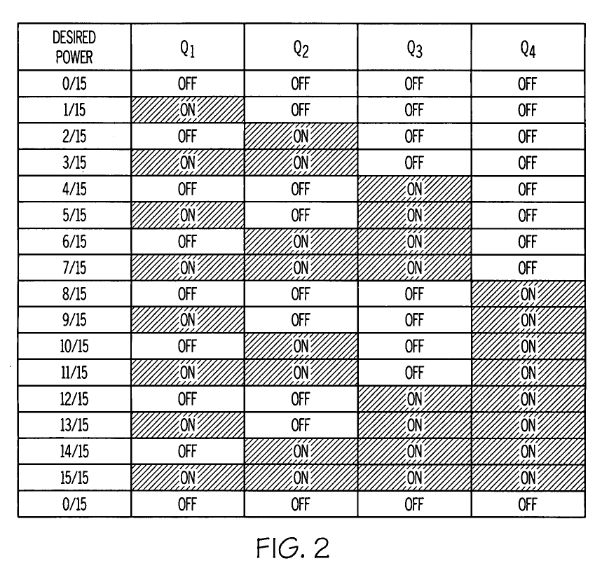

The following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment. It should also be understood that FIGS. 1-2 are merely illustrative and may not be drawn to scale.

FIG. 1 is a schematic diagram of a heater control system 20 in accordance with a first exemplary embodiment. As can be seen, the outputs of a plurality of switch driver circuits D₁, D₂, D₃, D₄, . . . , Dₙ are coupled to the base electrodes of power switches Q₁, Q₂, Q₃, Q₄, . . . , Qₙ, respectively. The emitter electrodes of power switches Q₁, Q₂, Q₃, Q₄, . . . , Qₙ are each coupled to a first source of potential (for example, −V), and their collector electrodes are each coupled to a second source of potential (for example, +V) through banks of heating elements H₁, H₂, H₃, H₄, . . . , Hₙ. Each heating element is shown as a resistor and may be assumed to have a resistance R. In the embodiment shown in FIG. 1, heater element banks H₁, H₂, H₃, H₄ and Hₙ are configured in a binary fashion; i.e., H₁ contains 2⁰ or one heating element, H₂ contains 2¹ or two parallel resistors, H₃ contains 2² or four parallel heating elements, H₄ contains 2³ or eight parallel heating elements, and so on such that Hₙ contains 2ⁿ⁻¹ heating elements.

The inputs of switch driver circuits D₁, D₂, D₃, D₄, . . . , Dₙ are respectively coupled to outputs of B₁, B₂, B₃, B₄, . . . , Bₙ of controller 22 that, in turn, has an input coupled to a signal Tᵢₙ that is indicative of a desired temperature or heating level. Tᵢₙ may result from the manipulation of a control mechanism located within the passenger compartment of a vehicle that is necessary to achieve a desired temperature. Controller 22 converts Tᵢₙ to the plurality of output signals (B₁, B₂, B₃, B₄, . . . , Bₙ) corresponding to a digital representation of Tᵢₙ (with B₁ corresponding to the least significant bit, B₂ corresponding to the next least significant bit, and so on) so as to selectively turn power switches Q₁, Q₂, Q₃, Q₄, . . . , Qₙ ON via drivers D₁, D₂, D₃, D₄, . . . , Dₙ to achieve the desired heating level. For example, if the digital representation of Tᵢₙ is 01010 . . . 0, only power switches Q₂ and Q₄ will be turned on resulting in current being drawn through the two heating elements in H₂ and the eight heating elements in H₄.

FIG. 2 represents an input command/duty-cycle table illustrating the fifteen power increments of an exemplary four-stage heating control system in accordance with the embodiment shown in FIG. 1. As can be appreciated, power switches Q₁, Q₂, Q₃, and Q₄ are switched in a binary fashion to provide effective power control of, for example, a PTC heater.

Stage 0/15 corresponds to minimum power; (i.e. B₁=B₂=B₃=B₄=0; thus, Q₁=Q₂=Q₃=Q₄=OFF). In this case, little or no current flows through any of the heating elements in banks H₁, H₂, H₃, and H₄ and therefore little or no heat is generated. Stage 15/15 corresponds to maximum power; (i.e. B₁=B₂=B₃=B₄=1; thus, Q₁=Q₂=Q₃=Q₄=ON). In this case, current flows through the single heating element in H₁, the two heating elements in H₂, the four heating elements in H₃, and the eight heating elements in H₄, thus generating maximum heat. It should thus be apparent that between minimum power stage 0/15 and maximum power stage 15/15, power may be incrementally increased or decreased as is shown by stages 2/15 through 14/15.

Certain strategies can be employed to minimize peak currents; for example, by providing a suitable time delay before switching up to the next power stage depending upon the relative size of the total resistance of the heating stage being turned ON. This permits in-rush current to subside prior to switching up to the next power stage. In addition, when maximum heating power is required, the process should begin with power stage 8/15, jump to power stage 12/15, then jump to power stage 14/15, and finally jump to power stage 15/15. This procedure minimizes peak currents and reaches maximum power as quickly as possible.

Peak currents can be further minimized by utilizing brake-before-make switching. For example, when switching from power stage 11/15 to power stage 12/15, Q₁ and Q₂ should be turned OFF before turning Q₃ ON.

Thus, there has been described a simplified heater control system particularly suitable for controlling a PTC heater. The system employs power/current amplitude modulation through the use of discrete power switches that drive various banks of heating elements. The result is a control system characterized by lower cost, reduced electromagnetic compatibility, and improved control.

The above description is given by way of example only. Changes in form and details may be made by one skilled in the art without departing from the scope of the invention. For example, heating banks H₁, . . . Hₙ have been illustrated as being configured in a binary configuration where each successive heating bank comprises two times the number in the previous heating bank. It should be appreciated that other configurations and/or groupings may be employed. For example, the number of heating elements in each grouping Hₙ may equal Xⁿ⁻¹ where X is a positive integer.

What is claimed is:

1. A heater control system, comprising:
a plurality of n banks of heating elements H₁, H₂, H₃, H₄, . . . , Hₙ each containing at least one heating element;
a plurality of switches Q₁, Q₂, Q₃, Q₄, . . . , Qₙ each one coupled to a respective one of the plurality of n banks for selectively activating the plurality of n banks; and
a plurality of control inputs each one coupled to a different one of the plurality of switches to selectively activate the plurality of switches.

2. A heater control system according to claim 1 wherein the plurality of control inputs is configured to receive a representation of a desired heating level.

3. A heater control system according to claim 2 wherein the representation is a digital representation.

4. A heater control system according to claim 3 further comprising a controller having an input for receiving a signal indicative of the desired heating level and having a plurality of outputs B₁, B₂, B₃, B₄ . . . , Bₙ each of the plurality of outputs coupled to one of the plurality of switches, the controller configured to convert the signal indicative of the desired heating level into the digital representation.

5. A heater control system according to claim 2 wherein each of the plurality of n banks comprises a different number of heating elements.

6. A heater control system according to claim 5 wherein each of the plurality of banks comprises Xⁿ⁻¹ heating elements where X is a positive integer.

7. A heater control system according to claim 5 wherein each successive heating bank comprises two-times the number of heating elements as the immediately preceding heating bank.

8. A heater control system according to claim 4 further comprising a plurality of driver circuits, each driver circuit having an input coupled to one of the plurality of outputs (B₁, B₂, B₃, B₄ . . . , Bₙ) of the controller, and each having an output corresponding to one of the control inputs.

9. A heater control system according to claim 1 wherein the switches are power transistors.

10. A heater control system according to claim 8 wherein the plurality of n banks comprises four banks (H₁, H₂, H₃, H₄) and wherein the plurality of outputs represents a four-bit binary representation (B₁, B₂, B₃, B₄) representative of the desired heating level.

11. A heater control system according to claim 10 wherein, when it is necessary to turn certain ones of switches Q₁, Q₂, Q₃, Q₄ OFF and other ones of switches Q₁, Q₂, Q₃, Q₄ ON, the controller is further configured to turn the certain ones OFF before turning the other ones ON.

12. A heater control system according to claim 11 wherein, when maximum heat is desired (Q₁, Q₂, Q₃, and Q₄ are ON), the controller is further configured to first transition to binary stage eight (Q₁, Q₂, Q₃ are OFF and Q₄ is ON), then next to binary stage twelve (Q₁, Q₂ are OFF and Q₃, Q₄ are ON), then next to binary stage fourteen (Q₁ is OFF and Q₂, Q₃, Q₄ are ON), and then next to binary stage fifteen (Q₁, Q₂, Q₃, and Q₄ are ON).

13. A heater control system comprising:
a plurality of n banks of heating elements (H₁, H₂, H₃, H₄, . . . , Hₙ) each bank having Xⁿ⁻¹ heating elements where X is a positive integer; and
a controller having an input for receiving a signal indicative of a desired heating level and having n outputs each one coupled to a respective one of the plurality n of banks, the controller configured to generate a binary representation of the signal on the n outputs to selectively activate the plurality of n banks of heating elements.

14. A system according to claim 13 further comprising a plurality of switches (Q₁, Q₂, Q₃, Q₄), each one having an output coupled to one of the plurality of n banks of heating elements and having an input coupled to one of the n outputs.

15. A system according to claim 14 further comprising a plurality of driver circuits each having an input coupled to a respective one of the n outputs and each having an output coupled to an input of a respective one of the plurality of switches.

16. A system according to claim 15 wherein the switches are power transistors.

17. A system according to claim 15 wherein the plurality of banks comprises four banks (H₁, H₂, H₃, H₄) and wherein the n outputs represent a four-bit binary representation (B₁, B₂, B₃, B₄) of the desired heating level.

18. A system according to claim 17 wherein when it is necessary to turn certain ones of switches Q₁, Q₂, Q₃, and Q₄ OFF and other ones of switches Q₁, Q₂, Q₃, and Q₄ ON, the controller is further configured to turn the certain ones OFF before turning the other ones ON.

19. A heater control system, comprising:
a plurality of n banks of heating elements (H₁, H₂, H₃, H₄, . . . , Hₙ), each bank comprising 2ⁿ heating elements;
a plurality of switches (Q₁, Q₂, Q₃, Q₄, . . . , Qₙ), each one coupled to a different one of the plurality of n banks;
a plurality of driver circuits, each one coupled to one of the plurality of switches; and
a controller having an input for receiving a signal indicative of a desired heating level and having n outputs each one coupled to a respective one of the plurality of driver circuits, the controller configured to generate a binary representation of the signal on the n outputs to selectively activate the plurality of banks of heating elements.

20. A system according to claim 19 wherein the plurality of banks comprises four banks (H₁, H₂, H₃, H₄,) and wherein the n outputs represent a four-bit binary representation (B₁, B₂, B₃, B₄) of the desired heating level, and wherein, when it is necessary to turn certain ones of switches Q₁, Q₂, Q₃, and Q₄ OFF and other ones of switches Q₁, Q₂, Q₃, and Q₄ ON, the controller is further configured to turn the certain ones OFF before turning the other ones ON.
